(19) United States
(12) Patent Application Publication
(10) Pub. No.: US 2026/0172270 A1
(43) Pub. Date: Jun. 18, 2026

(54) QUANTUM-RESISTANT HASHING FOR AUTHENTICATING PUBLIC COMMUNICATIONS ON QUANTUM-RESISTANT DISTRIBUTED LEDGER TECHNOLOGY

(71) Applicant: Bank of America Corporation, Charlotte, NC (US)

(72) Inventors: Vinesh Patel, Greenwich (GB); Michael Young, Davidson, NC (US); Maharaj Mukherjee, Poughkeepsie, NY (US); George Albero, Charlotte, NC (US); James Siekman, Charlotte, NC (US)

(21) Appl. No.: 18/971,885

(22) Filed: Dec. 6, 2024

(51) Int. Cl. H04L 9/00; H04L 9/32; H04L 9/40

(52) U.S. Cl. CPC H04L 9/50; H04L 9/3247; H04L 9/3297; H04L 63/08; H04L 63/0861

(57) ABSTRACT

Arrangements are provided for generating tamper-proof quantum-resistant data structures for storing digital communications transmitted over pubic electronic mediums, such as the Internet. The digital communication may include audio and video data. The tamper-proof quantum-resistant data structures may be stored in a repository used for verifying whether digital copies, such as video clips, are authentic copies or whether they have been altered, such as by artificial intelligence, to include misinformation or disinformation.

### BACKGROUND

Misinformation and disinformation are present problems due to the rapid dissemination of news and information over electronic media, such as the Internet, and the emergent capability of generative artificial intelligence (AI) to manipulate text and multimedia. Publicly available AI now allows anyone to alter news stories, corporate press releases, photos, multimedia, etc., to generate convincing fake and misleading information. Online social platforms allow the altered material to spread quickly and often be amplified due to algorithms that push information to users based on user biases and viewing history. At the same time, the ability of users to verify the information they receive is often limited or nonexistent, which leads to a lack of trust in the information and an inability to rely on the information in useful ways, such as making economic or investment decisions or using the information in scientific analysis.

### SUMMARY

The following summary is intended to provide a simplified understanding of some aspects of the disclosure. It is not a comprehensive overview, nor does it aim to identify key elements or delineate the scope of the disclosure. Instead, it serves as a brief introduction to the concepts discussed in the subsequent description.

Aspects of the disclosure provide effective, efficient, scalable, and convenient technical solutions that address and overcome the technical issues associated with storing digital communications in a tamper-proof and secure manner.

In some aspects, a computing platform may receive a plurality of digital communications via transmission over one or more public electronic mediums, encode the plurality of digital communications into a corresponding plurality of tamper-proof distributed ledgers, respectively, and maintain the plurality of tamper-proof distributed ledgers in a repository hosted by one or more servers and publicly accessible via the Internet. Each of the plurality of digital communications may include audio data or video data received via the Internet.

The computing platform may further receive, via a communication interface, an authentication request identifying one of the plurality of digital communications, and transmit, via the communication interface and in response to the authentication request, an authentication response that includes information adapted to verify that a digital copy matches a portion of the one of the plurality of digital communications identified in the authentication request.

In some examples, the authentication request may include the digital copy, and the authentication response may include an indication that the digital copy matches the portion of the one of the plurality of the digital communications identified in the authentication request.

In some aspects, for each digital communication of the plurality of digital communications, the computing platform may generate quantum-resistant hashes, respectively, from consecutive intervals of the digital communication and include the consecutive intervals of the digital communication and the quantum-resistant hashes into one of the plurality of tamper-proof distributed ledgers corresponding to the digital communication. I some examples, one or more of the quantum-resistant hashes may be included in the authentication response.

In some aspects, the computing platform may receive the digital copy within the authentication request and identify a duration within the portion of the digital communication that corresponds to the digital copy. The computing platform may further determine that the digital copy is an altered version of the duration within the portion of digital communication and indicate in the authentication response that the digital copy is an altered version.

Some examples include the computer platform generating quantum-resistant hashes, respectively, from consecutive intervals of the digital copy. The computer platform may determine that the digital copy is an altered version based on comparing the quantum-resistant hashes generated from the digital copy to the quantum-resistant hashes generated from the digital communication.

In some examples, the computing platform may encode the digital communications into tamper-proof distributed ledgers in real-time, for example, as they are received over the public electronic medium.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for the detection of altered copies of publicly disseminated digital communications in accordance with one or more aspects described herein;

FIGS. 2A-2B depict digital communications and a tamper-proof data structure in accordance with one or more aspects described herein;

FIG. 3 depicts a method for quantum-resistant hashing of and storage of digital communications on tamper-proof quantum-resistant chains according to one or more aspects described herein;

FIGS. 4A-4B illustrate methods of verifying a digital copy of a digital communication according to one or more aspects described herein; and

FIG. 5 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof and illustrate various embodiments in which aspects of the disclosure may be practiced. It is to be understood that other embodiments may be utilized, and structural and functional modifications may be made without departing from the scope of the present disclosure.

The following description discusses various connections between elements. These connections are general and, unless specified otherwise, may be direct or indirect, wired or wireless, and the specification is not intended to be limiting in this respect.

As discussed above, misinformation and disinformation are present problems due to the easy manipulation of public communications over digital platforms and the rapid pace at which manipulated communications are disseminated. The user's inability to verify received information leads to an inability to rely on the information in useful ways, such as making economic or investment decisions or using the information in scientific analysis. For instance, a CEO of a publicly traded company could put out a press release or stream an audio/video announcement over the Internet to shareholders to report quarterly earnings that beat forecasted expectations. A bad actor using a generative AI could capture and manipulate the announcement to generate a convincing altered copy that indicates that the company did not meet expectations. The bad actor can then spread the altered copy (e.g., through social media) as disinformation in order to maliciously manipulate stock investors and the stock price of the company.

Accordingly, aspects described herein are directed to storing publicly disseminated digital communications securely in a publicly available repository and providing a way to quickly verify whether copied portions of snippets of the digital communications are genuine and unaltered. This may include on-the-fly (e.g., in real-time) hashing (e.g., with a quantum-resistant hash) the digital communications as they are transmitted over a public electronic medium and storing the hashed digital communication in a tamper-proof quantum-resistant distributed ledger. The tamper-proof quantum-resistant distributed ledger may be stored in a publicly accessible repository (e.g., one or more servers), where it may be used to verify whether digital copies are authentic, e.g., because they are unaltered duplicates of portions of the original digital communication. These and various other arrangements will be discussed more fully below.

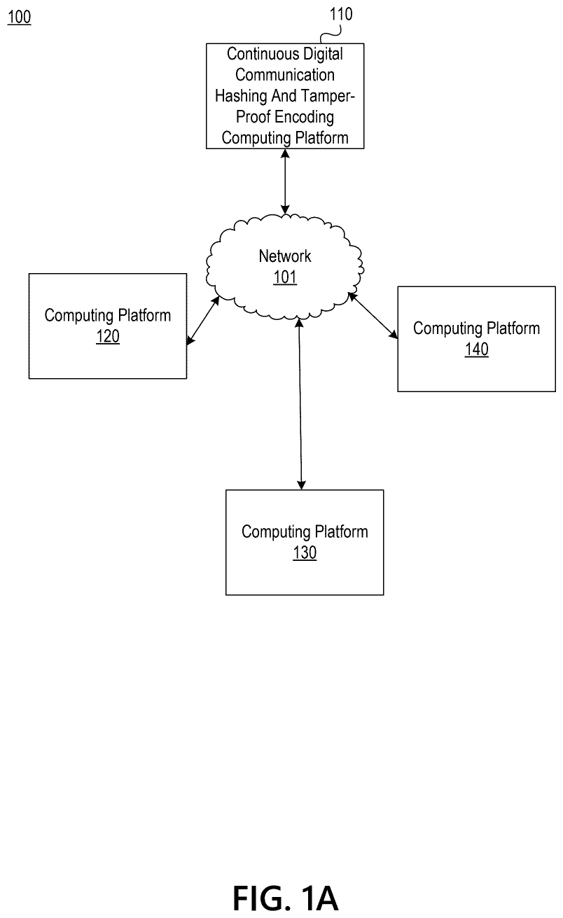

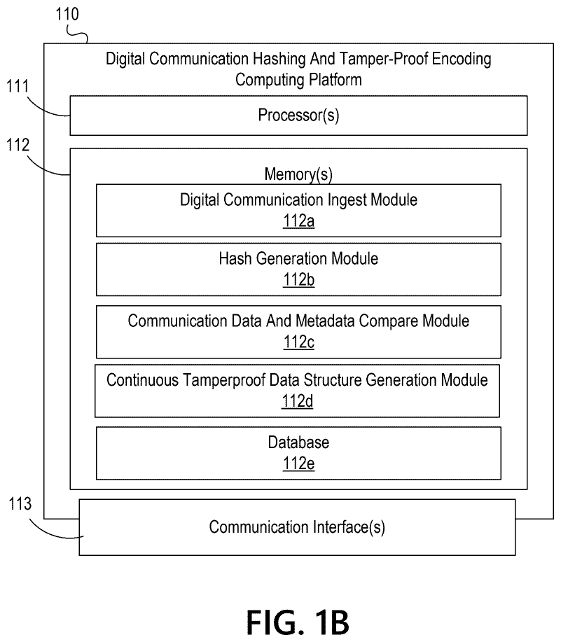

FIGS. 1A-1B depict an illustrative computing environment for the detection of altered copies of publicly disseminated digital communications.

Referring to FIG. 1A, computing environment 100 may include one or more computing devices and/or other computing systems. For example, computing environment 100 may include a continuous digital communication hashing and tamper-proof encoding computing platform 110, first computing device 120, second computing device 130, and third computing device 140.

Although three computing devices are shown, any number of systems or devices may be used without departing from the invention.

Continuous digital communication hashing and tamper-proof encoding computing platform 110 may be configured to perform intelligent, dynamic, real-time, and continuous monitoring of digital communication transmitted over one or more public electronic mediums from one or more sources, hashing of the data (e.g., using quantum-resistant hashing algorithms) and encoding of the hashed data in a tamper-proof distributed ledger, such as a quantum-resistant blockchain. As used herein for conciseness, digital communication may include text data, audio data, and/or video data, which may also be referred to generally as communication data. Examples of public electronic mediums include the Internet, World-Wide Web, cable systems, satellite systems, over-the-air broadcasts, cellular systems, and other mediums.

First computing device 120, second computing device 130, and/or third computing device 140 may be or include one or more computer components (e.g., servers, server blades, memory, processors, or the like) and may each include systems, applications, and the like, for receiving, decoding, storing, and/or presenting digital communications. Accordingly, first computing device 120, second computing device 130, and/or third computing device 140 may be a plurality of computing devices in a system for processing digital communications and may communicate with each other via machine-to-machine communication or data exchange to process digital communication data.

As mentioned above, computing environment 100 also may include one or more networks, which may interconnect one or more of continuous digital communication hashing and tamper-proof encoding computing platform 110, first computing device 120, second computing device 130, and/or third computing device 140. For example, computing environment 100 may include network 101, which may be a public or private network. Network 101 may include one or more sub-networks (e.g., Local Area Networks (LANs), Wide Area Networks (WANs), or the like). Network 101 may interconnect one or more computing devices associated with an organization with other devices, such as computers of individuals or other organizations that consume and share digital communications. For example, continuous digital communication hashing and tamper-proof encoding computing platform 110, first computing device 120, second computing device 130, and/or third computing device 140 may be connected via network 101.

Referring to FIG. 1B, continuous digital communication hashing and tamper-proof encoding computing platform 110 may include one or more processors 111, memory 112, and communication interface 113. A data bus may interconnect processor(s) 111, memory 112, and communication interface 113. Communication interface 113 may be a network interface configured to support communication between continuous digital communication hashing and tamper-proof encoding computing platform 110 and one or more networks (e.g., network 101 or the like). Memory 112 may include one or more program modules having instructions that, when executed by processor(s) 111, cause computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of computing platform 110 and/or by other computing devices that may form and/or otherwise make up computing platform 110.

For example, memory 112 may have, store, and/or include a digital communication ingest module 112a that may store instructions and/or data that may cause or enable the computing platform 110 to receive digital communications and metadata as further described below from other computing platforms such as first computing device 120, second computing device 130 and/or third computing device 140 from different data sources (different disseminators or digital communications). Computing platform 110 may further have, store, and/or include hash generation module 112b. Hash generation module 112b may store instructions and/or data that may cause or enable the computing platform 110 to generate hashes or tokens, including quantum-resistant hashes based on received digital communications, including text, audio, and/or video data and metadata. The received digital communications may include original digital communications as well as copies or all or portions of original digital communications. Hash generation module 112b may store instructions and/or data that may cause or enable the computing platform 110 to generate hashes or tokens, including quantum-resistant hashes based on headers for blocks in a quantum-resistant chain.

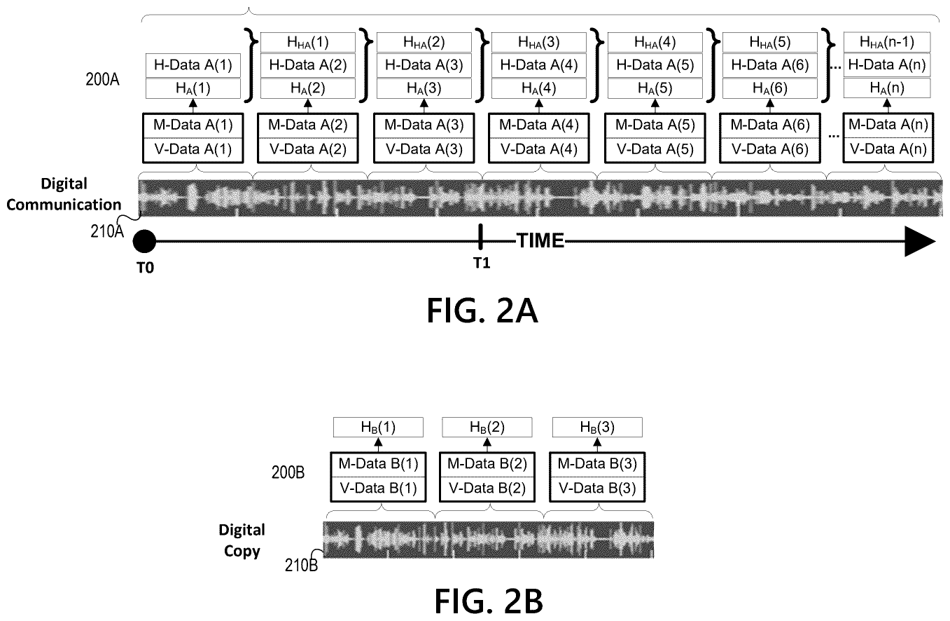

Computing platform 110 may further have, store, and/or include communication data and metadata compare module 112c that compares stored original digital communications to copies of digital communications. Compare module 112c may use various data matching algorithms, such as comparing metadata (e.g., timestamps) and/or hashes of the original and copied data to determine whether the data matches. Computing platform 110 may further have, store, and/or include a continuous tamperproof data structure generation module 112d that may generate tamperproof data structures such as those described below with respect to FIG. 2 using digital communication data, metadata, header data, and hashes generated by modules 112a-d.

Computing platform 110 may further include database 112e. Database 112e may store data related to the tamper-proof data structures, including digital communication data, metadata hashes of the voice/metadata, header data, and hashes of headers and/or other data to perform the functions of the computing platform 110.

Computing platforms 120, 130, and 140 may each include some or all of the components included in computing platform 110, as illustrated and described with respect to FIG. 1B.

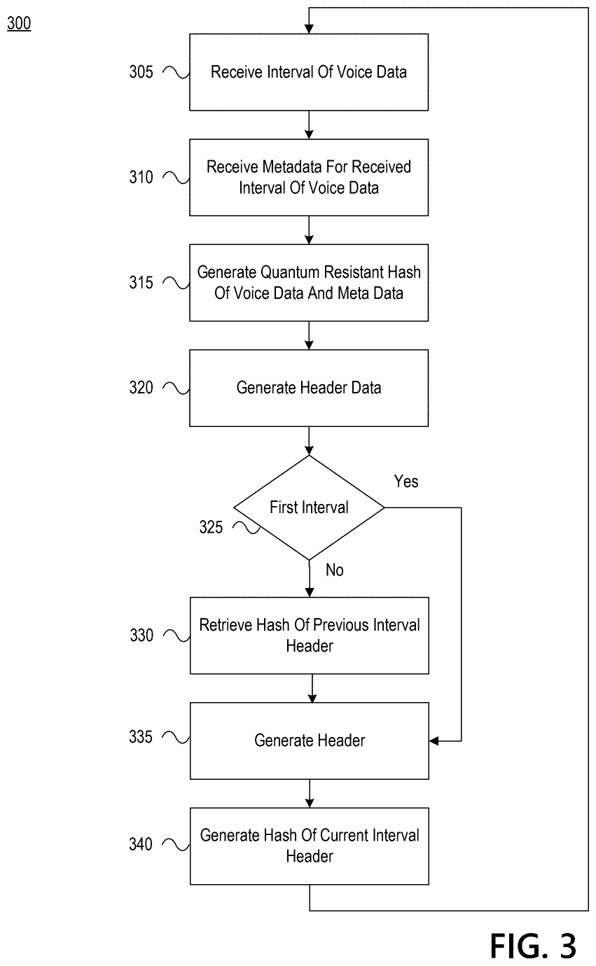

FIG. 2A depicts an example illustrative tamper-proof data structures (e.g., using distributed ledger technology) that may be generated according to a process 300 illustrated in FIG. 3, which may provide continuous digital communication hashing and tamper-proof encoding in accordance with one or more aspects described herein. FIG. 2B depicts an example data structure of a digital copy with hashes that may be generated with certain steps of process 300. The data structures in FIGS. 2A and 2B are merely a few examples, and other tamper-proof data structures may be encoded without departing from the invention. For example, the data structures may be formed as blockchains (or other linked lists), sidechains (or other lists of linked lists), or directed acyclic graphs, such as tangles or hash graphs. The tamper-proof encoding may alternatively or additional use lattice-based cryptography, code-based cryptography, and multivariate cryptography.

Process 300 in FIG. 3 is merely one example sequence, and additional steps may be added or omitted. The steps may be performed in different orders than illustrated without departing from the invention. Process 300 may be performed in real-time and/or continuously, for example, as digital communications are generated from data sources (e.g., a streaming or broadcast source). Additionally, or alternatively, process 300 may be performed on data digital communication after the digital communication has been generated and stored, e.g., in a database. Additionally or alternatively, process 300 (or parts thereof) may be performed on digital copies, as shown in FIG. 2B, which may be unaltered or altered copies of all or a portion of a digital communication, such as illustrated in FIG. 2A.

FIG. 2A illustrates two tamper-proof chains of data generated from a communication (e.g., video and/or audio) transmitted over a public electronic medium, such as the Internet. While the communication is generally referred herein to as text, video, or audio, the communication could be any electronic communication transmitted from a source and received by one or more destinations, either point-to-point (e.g., a phone call), from one-to-many (e.g., in a conference call, or stream), or one-to-all (e.g., in a broadcast), such as between computer platforms 120, 130, and 140 (e.g., personal computers). The digitial communication may be human or computer generated.

From a source (e.g., computer platform 120), digital communication 211A may be generated and communicated (e.g., transmitted) to destinations (e.g., communication platforms 120, 130, and 140). Generally, digital communication 210A as it is transmitted from the source (e.g., 120) will be identical or nearly identical to as it is received (e.g., at 110, 130, 140) because of its digital encoding, which may include mechanisms for error detection and corrections.

The digital communication may be divided into intervals (e.g., every 1 nanosecond, 1 microsecond, 1 millisecond, 1 second, 10 seconds, etc.) over the duration of the digital communication. For example, digital communication 210A may be divided into sequential intervals V-Data A(1) through V-Data A(n). In some examples, the interval size for each caller may be the same, though in others, they may be different sizes. In some examples, for each interval of the digital communication, there may be metadata that is generated (e.g., by computer platforms 110, 120, 130, or 140), that includes information like dates and times the interval of digital communication was generated, interval size, a file name the digital communication is contained in, coding format of the digital communication, etc. For example, V-Data A(1) through V-Data A(n) may have associated therewith, metadata M-Data A(1) through M-Data A(n), respectively.

FIG. 2B illustrates an example of a copy 210B of all or a portion of digital communication 210A. Copy 210B may be generated by a receiver (e.g., 110, 130, or 140) of the original digital communication transmitted by the source (e.g., 120B). Aspects are directed to determining whether digital copy 210B is an unaltered copy of a portion of digital communication 210A. Similar to the original digital communication, digital copy 210B may be divided into intervals (e.g., every 1 nanosecond, 1 microsecond, 1 millisecond, 1 second, 10 seconds, etc.) over the duration of the digital communication. For example, digital communication 210A may be divided into sequential intervals, such as V-Data B(1) through V-Data B(m) (only the first three intervals are shown, for example). Like the intervals of the original communication, the intervals of the digital copy V-Data B(1) through V-Data B(n) may have associated therewith, metadata M-Data B(1) through M-Data B(n), respectively. One or more of the sequential intervals and metadata of digital copy 210B may match the corresponding intervals and metadata of the original communication 210A.

For each interval of digital communication 210A and optionally corresponding metadata, a corresponding header is generated. Together, the interval of digital communication, metadata, and header form a block of data in a tamper-proof data structure. With reference to FIG. 3, to encode the digital communication in FIG. 2A in a tamper-proof data structure, a computing platform such as 110, 120, 130, and/or 140 may receive in step 305 an interval of digital communication (e.g., V-Data A(1)) and optionally receive in step 310 the metadata corresponding to the interval of digital communication (e.g., M-Data A(1)).

At step 315, a computing platform such as 110, 120, 130, and/or 140 may generate a hash or token (e.g., H_{A}(1)) based on the received digital communication interval (e.g., V-Data A(1)), and optionally, the corresponding metadata (e.g., M-Data A(1)). The cryptographic hashing algorithm to generate the hash or token may be quantum-resistant, such that it is secure against attacks with a quantum computer (e.g., running Shor's Algorithm). Examples of quantum-resistant cryptographic hashing algorithms include Lamport signatures, Merkle signature schemes, Extended Merkle signature scheme (XMSS), SPHINCS, SPHINCS+, Crystals-Dilithium,

### Falcon, Etc.

Steps 305, 310, and 315 may also be used (e.g., by 110, 120, 130, and/or 140) to generate a hash or token for intervals of digital copy 210B and optionally corresponding metadata. The cryptographic hashing algorithm to generate the hash or token for digital copy 210 may be the same as for digital communication 210A. If an interval (and optionally metadata) of digital copy 210B is the same as an interval (and optionally metadata) of digital communication 210A, the generated hashes or tokens of each will match or be uniquely related (such as one being derivable from the other).

At step 320, for an interval of digital communication, a computing platform such as 110, 120, 130, and/or 140 may generate header data. For example, for V-Data A(1), header data H-Data A(1) may be generated. Upon completion of process 300, header data may be generated for some or all of each interval of digital communication 210A. For example, in FIG. 2A, V-Data A(1) through V-Data A(n) may have associated therewith, header data H-Data A(1) through H-Data A(n), respectively.

The header data for each block may include information about the communication and information about the tamper-proof data structure. Information about the communication may include, for example, information identifying the source, about the computing platforms or network connections, such as IP and MAC addresses and the computing platforms'geographical and/or physical locations, etc. Information about the tamper-proof data structure may include, for example, a timestamp of when the header was created, memory pointers to the digital communication, metadata, and other information in the block, memory pointers to one or more preceding blocks, a cryptographic nonce, a pointer to a root node or leaf node (e.g., in a Merkle tree), etc.

At step 325, a computing platform such as 110, 120, 130, and/or 140 may determine whether the corresponding digital communication interval for the block is the first interval of the digital communication, for example, such as V-Data A(1). If the digital communication interval is not the first interval, the process may proceed to step 330, in which a computing platform such as 110, 120, 130, and/or 140 retrieves a hash of the header for the previous data block (e.g., including the previous interval of digital communication). From step 330, the process may proceed to step 335. If in step 325, the digital communication interval is the first interval, the process may skip to step 330 and proceed to step 335.

At step 335, a computing platform such as 110, 120, 130, and/or 140 may generate a header for the block, which may include the hash of the digital communication (and optionally metadata) for the current interval (e.g., H_{A}(1), H_{A}(2), etc.), the header data for the current interval (e.g., H-Data A(1), H-Data A(2)). If the current block is not the first block, the header may include the hash of the previous block's header (e.g., H_{HA}(1), etc.).

At step 340, a computing platform such as 110, 120, 130, and/or 140 may generate a hash or token (e.g., H_{HA}(1), H_{HA}(2), etc.) based on the current header (e.g., including H-Data A(1) and H_{A}(1), including H-Data A(2) and H_{A}(2), and H_{HA}(1), etc.). Similar to the cryptographic hashing algorithm for the voice and metadata, the cryptographic hashing algorithm for the header may generate a quantum-resistant hash or token, such that it is secure against attacks with a quantum computer (e.g., running Shor's Algorithm). In these examples, the header data and/or the hash of the previous header provide a secure link between each block and make the encoding of each block dependent upon the previous block(s), which, together with the quantum-resistant hashes, make the data structure resistant to tampering (e.g., with a quantum computer). While the examples include a linear link of blocks, other quantum-resistant structures that include linked blocks may be used, including Lamport signatures, Merkle signature schemes, Extended Merkle signature scheme (XMSS), SPHINCS, SPHINCS+, Crystals-Dilithium, FALCON, etc.

After step 340, the process may return to step 305 to process the next interval of digital communication. Process 300 may continue for each data source of digital communication until the voice ends. This may result in a tamper-proof data structure 200A including digital communication V-Data A(1) through V-Data A(n), metadata M-Data A(1) through M-Data A(n), digital communication hashes H_{A}(1) through H_{A}(n), header data H-Data A(1) through H-Data A(n), and header hashes H_{HA}(1) through H_{HA}(n−1). Examples of process 300 may combine steps or perform certain steps in different orders. For example, step 325 may be eliminated, and step 330 may retrieve a null value if the interval is the first block. In another example, step 340 may performed at any time in any sequence when all header data for the block has been determined. Process 300 may be performed continuously and/or in real-time, for example, as each interval of digital communication is generated during a call, or may be performed after some or all of the digital communication is generated and stored in a memory.

In various examples, the performance of process 300 may be performed by a single computing platform 110, 120, 130, and/or 140, or the steps of process 300 may be distributed amongst the computing platforms. For example, the retrieval of the digital communication and metadata, and the generation of the hash of the digital communication and metadata may be performed by the computing platform from which the digital communication originates. Generation of the header data and the hash for the header data may be performed by computing platform 110. As an alternative, computing platform 110 may perform the entirety of process 300. In other examples, computing platforms 110, 120, 130, and/or 140, together, perform the steps of process 300 for a single data source.

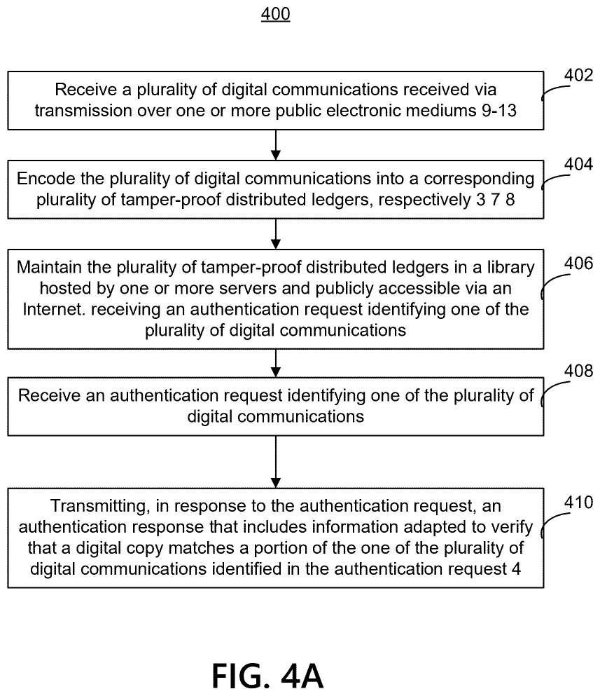

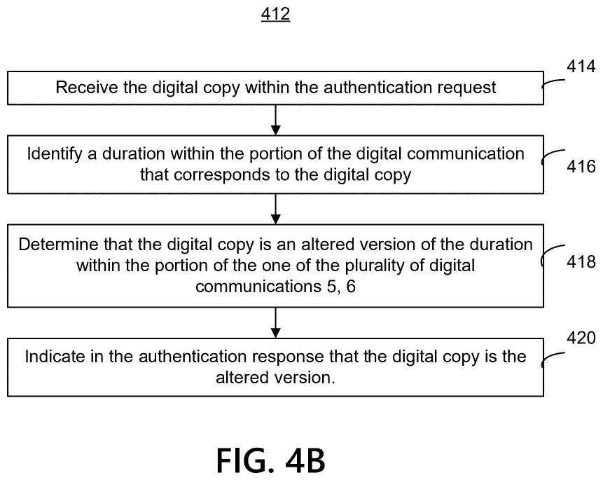

FIGS. 4A-4B illustrate methods of determining whether a digital copy (e.g., 210B) of a digital communication (e.g., 210A) is authentic or whether it has been manipulated or otherwise does not match a portion of the original digital communication.

In FIG. 4A, process 400 begins with step 402, in which a computing platform (e.g., 110) may include at least one processor, a communication interface communicatively coupled to the at least one processor, and a memory storing computer-readable instructions that cause the computing platform to receive a plurality of digital communications received via transmission over one or more public electronic mediums. In some examples, the computing platform that receives the digital communications may be the same as the computing platform that transmits them. That is, a computing platform may transmit a digital communication and also keep a copy of the transmission for further processing according to Process 400. As discussed above, the plurality of digital communications comprises audio data or video data received via the Internet. One or more public electronic mediums may include transmission over a communication network via a web application, a broadcast transmission, or a multicast transmission. For example, the transmission may be over a cable (e.g., fiber or coax cable), over the air from a satellite, over the air from a ground-based antenna, or over the air from a cellular tower. The medium may be any wired or wireless radio-frequency transmission. In some examples, one or more public electronic mediums include transmission of the plurality of digital communications (e.g., in packets) via a World Wide Web or the Internet, e.g., through a plurality of networks, including home wireless or wired networks. The plurality of digital communications may be accessible to anyone with access to the one or more public electronic mediums.

In step 404, the computer-readable instructions may cause the computing platform (e.g., 110) to encode the plurality of digital communications into a corresponding plurality of tamper-proof distributed ledgers, respectively. In some aspects, each digital communication may be encoded as previously discussed with respect to FIGS. 2A and 3, for example, by a computer platform performing process 300. For example, encoding a digital communication may include generating quantum-resistant hashes, respectively, from consecutive intervals of the digital communication as discussed above with respect to step 315, and including the consecutive intervals of the digital communication and the quantum-resistant hashes into one of the plurality of tamper-proof distributed ledgers corresponding to the digital communication as discussed above with respect to steps 320-340.

As previously described, each tamper-proof distributed ledger of the plurality of tamper-proof distributed ledgers may include a sequence of blocks, as shown in FIG. 2A. Each block may include an interval of a sequence of intervals of one of the digital communications. The computing platform may generate a secure digital communication hash from the interval, header data, and a header hash. The header hash for each block may be generated from the secure digital communication hash, the header data, and the header hash of a previous block in the sequence. Step 404 may include encoding the sequence of blocks in real time as the digital communication is received. In some examples, the computing platform may use a quantum computer and/or an artificial intelligence engine to generate the tamper-proof ledger. For example, an artificial intelligence engine may be used to analyze each interval of the digital communication and generate header data corresponding to the interval to add relevant information about the interval. In some aspects, a quantum computer may be used to generate the hash for each interval and/or block in real time.

In step 406, the computer-readable instructions may cause the computing platform (e.g., 110) to maintain the plurality of tamper-proof distributed ledgers in a repository hosted by one or more servers and publicly accessible via the Internet. The repository may include one or more servers accessible to the public (e.g., to anyone with access to the network, Internet, etc.). The repository may be used by users to verify whether copies of digital communications or portions of digital communications are authentic and unmodified or whether the copies are altered versions of the digital communications or do not match any of the digital communications in the repository. For example, a company that streams an earnings report on the Internet may encode the stream in a tamper-proof distributed ledger in the repository. The streamed report may be posted on the company's website along with a link to the repository to verify any copies of the report. One application may be in news reporting. A news organization may include a clip of the report on the news organization's website or in a post on a social media platform and include a link to the stream in the repository with the clip. In this way, a reader can verify for themselves if the clip is a genuine copy of the stream or if it is doctored or altered, e.g., to include misinformation or disinformation.

In step 408, the computer-readable instructions may cause the computing platform (e.g., 110) to receive an authentication request identifying one of the plurality of digital communications. The authentication request may be generated or sent from a weblink, as described in the previous step. The authentication request may identify an entire digital communication or a specific portion of the digital communication to be verified.

In step 410, the computer-readable instructions may cause the computing platform (e.g., 110) to transmit, in response to the authentication request, an authentication response. The authentication response may include information adapted to verify that a digital copy matches a portion of the one of the plurality of digital communications identified in the authentication request.

For example, in response to the request, the response may include one or more of the quantum-resistant hashes generated from the consecutive intervals of the portion of the one of the plurality of digital communications identified in the authentication request. As discussed above with respect to FIG. 2B, another computing platform (e.g., that sent the request) may calculate quantum-resistant hashes for intervals of a digital copy, e.g., according to steps 305-315 of process 300) using the same algorithm used to generate the quantum-resistant hashes for the digital communication in the tamper-proof distributed ledger. The other computing platform may then compare the quantum-resistant hashes received in the authentication response to those generated for the digital copy to verify if they match. A match would indicate that the intervals of the digital copy are the same as the intervals of the original digital communication. A comparison that shows some of the hashes matching and others not matching may show that the digital copy originated from the original digital communication but was altered in some way.

In other examples, process 412 includes steps that may be taken alternatively to, or in addition to, steps 408 and 410 of process 400. FIG. 4B illustrates process 412, which may be performed by a computing platform (e.g., 110) to determine whether a digital copy is an altered version of a portion of an original communication stored in a tamperproof data structure as described above. Process 412 may be performed by the same computing platform that hosts the repository and/or performs the steps of process 400.

Process 412 begins with step 414, in which computer-readable instructions may cause the computing platform (e.g., 110) to receive the digital copy within the authentication request (e.g., in step 408), e.g., so that the computing platform can process the digital copy to determine its authenticity. The digital copy may include metadata as previously described with respect to FIG. 2B.

In step 416, the computer-readable instructions may cause the computing platform (e.g., 110) to identify a duration within the portion of the digital communication that corresponds to the digital copy. The authentication request may include an indication of a particular portion (e.g., particular intervals) of the digital communication to which the digital copy is to be compared. In some examples, the duration is determined by analyzing the metadata of the digital copy, which may include, for example, timestamps or other information indicating which portion of the digital communication it is a copy of.

In step 418, computer-readable instructions may cause the computing platform (e.g., 110) to determine that the digital copy is an altered version of the duration within the portion of the one of the plurality of digital communications. For example, the computing platform may generate quantum-resistant hashes, respectively, from consecutive intervals of the digital copy as previously described with respect to FIG. 2B and steps 305-315 of process 300 of FIG. 3. The same algorithm may be used to generate the quantum-resistant hashes for the digital communication in the tamper-proof distributed ledger. The computing platform may then determine whether the digital copy is the altered version, accurate version, or a non-matching version of the portion of the digital communication based on comparing the quantum-resistant hashes generated from the digital copy to the quantum-resistant hashes generated from the digital communication. As indicated above, a match of the hashes would indicate that the intervals of the digital copy are the same as the intervals of the original digital communication. A comparison that shows some of the hashes matching and others not matching may show that the digital copy originated from the original digital communication but was altered in some way. If no hashes match, the digital copy may be indicated as having no match to the digital communication.

In step 420, the computer-readable instructions may cause the computing platform (e.g., 110) to indicate in the authentication response that the digital copy is an altered version, accurate version, or non-matching version of all or a portion of the digital communication as determined in step 418.

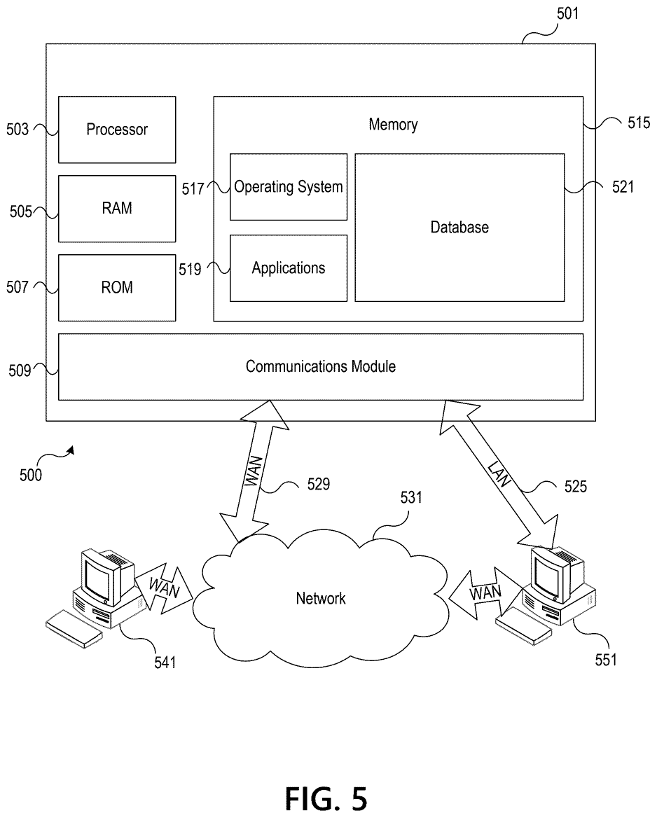

FIG. 5 depicts an illustrative operating environment in which various aspects of the present disclosure may be implemented in accordance with one or more example embodiments. Computing System Environment 500 is only one example of a suitable computing environment. It is not intended to suggest any limitation regarding the scope of use or functionality contained in the disclosure. Computing System Environment 500 should not be interpreted as having any dependency or requirement relating to any one or combination of components shown in illustrative Computing System Environment 500. Computing System Environment 500 elements for implementing any of the computing platforms (e.g., 110, 120, 130, 140) in addition or as an alternative to those elements as described above with respect to FIGS. 1A-1B.

Computing system environment 500 may include processor 503 for controlling the overall operation of computing device 501 and its associated components, including Random Access Memory (RAM) 505, Read-Only Memory (ROM) 507, communications module 509, and memory 515. Computing device 501 may include a variety of computer-readable media. Computer-readable media may be any available media that may be accessed by computing device 501, may be non-transitory, and may include volatile and nonvolatile, removable and non-removable media implemented in any method or technology for storage of information such as computer-readable instructions, object code, data structures, program modules, or other data. Examples of computer-readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor (e.g., hardware processor) on computing device 501. Such a processor may execute computer-executable instructions stored on a computer-readable medium.

Software may be stored within memory 515 and/or storage to provide instructions to processor 503 for enabling computing device 501 to perform various functions as discussed herein. For example, memory 515 may store software used by computing device 501, such as operating system 517, application programs 519, and associated database 521. Also, some or all of the computer-executable instructions for computing device 501 may be embodied in hardware or firmware. Although not shown, RAM 505 may include one or more applications representing the application data stored in RAM 505 while computing device 501 is on and corresponding software applications (e.g., software tasks) are running on computing device 501.

Communications module 509 may include a microphone, keypad, touch screen, and/or stylus through which a user of computing device 501 may provide input. It may also include one or more speakers for audio output and a video display device for textual, audiovisual, and/or graphical output. Computing system environment 500 may also include optical scanners (not shown).

Computing device 501 may operate in a networked environment supporting connections to one or more remote computing devices, such as 541 and 551. Computing devices 541 and 551 may be personal computing devices or servers that include any or all of the elements described above relative to computing device 501.

The network connections depicted in FIG. 5 may include Local Area Network (LAN) 525 and Wide Area Network (WAN) 529, as well as other networks. When used in a LAN networking environment, computing device 501 may be connected to LAN 525 through a network interface or adapter in communications module 509. When used in a WAN networking environment, computing device 501 may include a modem in communications module 509 or other means for establishing communications over WAN 529, such as network 531 (e.g., public network, private network, Internet, intranet, and the like). The network connections shown are illustrative, and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP), and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smartphones, multiprocessor systems, microprocessor-based systems, set-top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, etc. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to implement one or more aspects of the disclosure more effectively, and such data structures are contemplated to be within the scope of computer-executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events described herein may be transferred between a source and a destination in light or electromagnetic waves traveling through signal-conducting media such as metal wires, optical fibers, or wireless transmission media (e.g., air or space). In general, one or more computer-readable media may be and/or include one or more non-transitory computer-readable media.

As described herein, the various methods and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the single computing platform may perform the various functions of each computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method for safeguarding authenticity of electronically distributed public communications, comprising:
receiving a plurality of digital communications via transmission over one or more public electronic mediums;
encoding the plurality of digital communications into a plurality of tamper-proof distributed ledgers, respectively;
maintaining the plurality of tamper-proof distributed ledgers in a repository hosted by one or more servers and publicly accessible via an Internet;
receiving an authentication request that identfies one of the plurality of digital communications; and
transmitting, in response to the authentication request, an authentication response that includes information adapted to verify that a digital copy matches a portion of the one of the plurality of digital communications identified in the authentication request.

2. The method of claim 1, wherein:
the authentication request includes the digital copy; and
the authentication response includes an indication that the digital copy matches the portion of the one of the plurality of the digital communications identified in the authentication request.

3. The method of claim 1, further comprising, for each digital communication of the plurality of digital communications:
generating quantum-resistant hashes, respectively, from consecutive intervals of the digital communication; and
including the consecutive intervals of the digital communication and the quantum-resistant hashes into one of the plurality of tamper-proof distributed ledgers corresponding to the digital communication.

4. The method of claim 3, wherein the authentication response includes one or more of the quantum-resistant hashes generated from the consecutive intervals of the one of the plurality of digital communications identified in the authentication request.

5. The method of claim 3, further comprising,
receiving the digital copy within the authentication request;
identifying a duration within the portion of the one of the plurality of digital communications that corresponds to the digital copy;
determining that the digital copy is an altered version of the duration within the portion of the one of the plurality of digital communications; and
indicating in the authentication response that the digital copy is the altered version.

6. The method of claim 5, further comprising:
generating quantum-resistant hashes, respectively, from consecutive intervals of the digital copy, wherein the determining that the digital copy is the altered version is based on comparing the quantum-resistant hashes generated from the digital copy to the quantum-resistant hashes generated from the one of the plurality of digital communications.

7. The method of claim 1, wherein each tamper-proof distributed ledger of the plurality of tamper-proof distributed ledgers includes a sequence of blocks, each including:
an interval of a sequence of intervals of a digital communication of the plurality of digital communications corresponding to the tamper-proof distributed ledger;
a secure digital communication hash generated from the interval;
header data; and
a header hash, wherein the header hash of each block in the sequence of blocks is generated from the secure digital communication hash, the header data and the header hash of a previous block in the sequence of blocks.

8. The method of claim 7, further comprising, encoding the sequence of blocks in real time as the digital communication corresponding to the tamper-proof distributed ledger is received.

9. The method of claim 1, wherein each of the plurality of digital communications comprises audio data or video data received via the Internet.

10. A computing platform for safeguarding authenticity of electronically distributed public communications, the computing platform comprising:
at least one processor;
a communication interface communicatively coupled to the at least one processor and a memory storing computer-readable instructions that, when executed by the at least one processor, cause the computing platform to:
receive a plurality of digital communications via transmission over one or more public electronic mediums;
encode the plurality of digital communications into a plurality of tamper-proof distributed ledgers, respectively;
maintain the plurality of tamper-proof distributed ledgers in a repository hosted by one or more servers and publicly accessible via an Internet;
receive, via the communication interface, an authentication request that identifies one of the plurality of digital communications; and
transmit, via the communication interface and in response to the authentication request, an authentication response that includes information adapted to verify that a digital copy matches a portion of the one of the plurality of digital communications identified in the authentication request.

11. The computing platform of claim 10, wherein:
the authentication request includes the digital copy; and
the authentication response includes an indication that the digital copy matches the portion of the one of the plurality of the digital communications identified in the authentication request.

12. The computing platform of claim 10, wherein the computer-readable instructions, when executed by the at least one processor, causes the computing platform to, for each digital communication of the plurality of digital communications:
generate quantum-resistant hashes, respectively, from consecutive intervals of the digital communication; and
include the consecutive intervals of the digital communication and the quantum-resistant hashes into one of the plurality of tamper-proof distributed ledgers corresponding to the digital communication.

13. The computing platform of claim 12, wherein the authentication response includes one or more of the quantum-resistant hashes generated from the consecutive intervals of the one of the plurality of digital communications identified in the authentication request.

14. The computing platform of claim 12, wherein the computer-readable instructions, when executed by the at least one processor, causes the computing platform to:
receive the digital copy within the authentication request;
identify a duration within the portion of the one of the plurality of digital communications that corresponds to the digital copy;
determine that the digital copy is an altered version of the duration within the portion of the one of the plurality of digital communications; and
indicate in the authentication response that the digital copy is the altered version.

15. The computing platform of claim 14, wherein the computer-readable instructions, when executed by the at least one processor, causes the computing platform to:
generate quantum-resistant hashes, respectively, from consecutive intervals of the digital copy, wherein the determining that the digital copy is the altered version is based on comparing the quantum-resistant hashes generated from the digital copy to the quantum-resistant hashes generated from the one of the plurality of digital communications.

16. The computing platform of claim 10, wherein each tamper-proof distributed ledger of the plurality of tamper-proof distributed ledgers includes a sequence of blocks, each including:
an interval of a sequence of intervals of a digital communication of the plurality of digital communications corresponding to the tamper-proof distributed ledger;
a secure digital communication hash generated from the interval;
header data; and
a header hash, wherein the header hash of each block in the sequence of blocks is generated from the secure digital communication hash, the header data and the header hash of a previous block in the sequence of blocks.

17. The computing platform of claim 16, wherein the computer-readable instructions, when executed by the at least one processor, causes the computing platform to:
encode the sequence of blocks in real time as the digital communication corresponding to the tamper-proof distributed ledger is received.

18. One or more non-transitory computer-readable media storing instructions that, when executed by a computing platform comprising at least one processor, memory, and a communication interface, cause the computing platform to:
receive a plurality of digital communications via transmission over one or more public electronic mediums;
encode the plurality of digital communications into a plurality of tamper-proof distributed ledgers, respectively;
maintain the plurality of tamper-proof distributed ledgers in a repository hosted by one or more servers and publicly accessible via an Internet;
receive, via the communication interface, an authentication request that identifies one of the plurality of digital communications and including a digital copy; and
transmit, via the communication interface and in response to the authentication request, an authentication response that includes an indication that the digital copy does not match or is an altered version a portion of the one of the plurality of the digital communications identified in the authentication request.

19. The one or more non-transitory computer-readable media of claim 18, wherein the instructions, when executed by the computing platform, cause the computing platform to:
identify a duration within the portion of the one of the plurality of the digital communications that corresponds to the digital copy;
determine that the digital copy is the altered version of the duration within the portion of the one of the plurality of digital communications; and
indicate in the authentication response that the digital copy is the altered version.

20. The one or more non-transitory computer-readable media of claim 18, wherein the instructions, when executed by the computing platform, cause the computing platform to:
generate quantum-resistant hashes, respectively, from consecutive intervals of the digital copy; and
compare the quantum-resistant hashes generated from the digital copy to the quantum-resistant hashes generated from the one of the plurality of digital communications.
